(19) United States
(12) Patent Application Publication
(10) Pub. No.: US 2025/0370126 A1
(43) Pub. Date: Dec. 4, 2025

(54) SCHOOL VEHICLE SAFETY SYSTEM USING RADAR SENSOR

(71) Applicant: SMART RADAR SYSTEM, INC., Seongnam-si (KR)

(72) Inventors: Young Woo JEONG, Suwon-si (KR); Yong Jae KIM, Yongin-si (KR)

(73) Assignee: SMART RADAR SYSTEM, INC., Seongnam-si (KR)

(21) Appl. No.: 19/220,265

(22) Filed: May 28, 2025

(30) Foreign Application Priority Data
May 29, 2024 (KR) 10-2024-0070031

(51) Int. Cl. G01S 13/931; G01S 13/60; G01S 13/88

(52) U.S. Cl. CPC G01S 13/931; G01S 13/60; G01S 13/886; G01S 2013/93271; G01S 2013/93274

(57) ABSTRACT

A school vehicle safety system using a radar sensor according to one aspect of the present invention is provided to generate an alarm to provide a warning of detection when an object in motion is detected at a forward lower side of a school vehicle by a lower short-range radar sensor.

### CROSS-REFERENCE TO RELATED APPLICATION(S)

This application claims priority from Korean Patent Application No. 10-2024-0070031, filed on May 29, 2024, in the Korean Intellectual Property Office, the disclosure of which is incorporated herein by reference in its entirety.

### BACKGROUND

### 1. Field

The following description relates to a safety management technology for a school vehicle, and more particularly, to a technology for detecting an object in the vicinity of a school vehicle using a radar sensor.

### 2. Description of Related Art

Educational institutions such as schools operate school vehicles such as school buses to provide transportation for children. However, accidents have occurred due to a failure to properly check whether all children have gotten off the school vehicle, or a failure to notice children approaching the school vehicle, or in particular, children who have gone under the vehicle when the vehicle is departing.

Korean Registered Patent No. 10-1388689 discloses a technology of preventing an accident by installing an RF receiving terminal inside a school vehicle and providing a child using a school vehicle with an RF signal emitting terminal such that a driver may recognize whether the child gets on or get off the vehicle and whether the RF signal emitting terminal moves outside a set area upon getting off the vehicle. Such a conventional technology may have a limitation in terms of detecting children approaching the school vehicle when the children do not bring the RF signal emitting terminal with them or are temporarily separated from the RF transmitting terminal (e.g., when the RF signal emitting terminal is attached to a bag but the bag is placed separately).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a safety system capable of detecting the approach of a child approaching the vicinity of a school vehicle using a radar and generating an alarm.

The following description also relates to a safety system capable of detecting a child who has entered a space under a school vehicle using a radar and generating an alarm.

The following description also relates to a safety system capable of detecting a departure of a school vehicle without delay using a radar and preventing unneeded alarms that may occur due to movement of the vehicle.

In one general aspect, a school vehicle safety system using a radar sensor includes a lower short-range radar sensor and an alarm controller.

The lower short-range radar sensor is configured to detect a moving object at a forward lower side of a school vehicle.

The alarm controller is configured to receive an object detection result from the lower short-range radar sensor, determine whether an alarm has been generated from a lower side of the school vehicle, output a warning sound through a speaker, and flash one or more light emitting diodes (LEDs) according to a result of the determination to indicate the result of the determination.

In an additional general aspect, the school vehicle safety system may further include a speed detection short-range radar sensor.

The speed detection short-range radar sensor may be configured to emit a radar signal at a first angle with respect to a bottom surface of the school vehicle at a rear lower side of the school vehicle and detect a moving speed of the school vehicle based on a signal reflected from the radar signal.

In the aspect, the alarm controller may be configured to stop an operation of the lower short-range radar sensor when the moving speed of the school vehicle received from the speed detection short-range radar sensor is greater than a preset first speed.

In an additional general aspect, the school vehicle safety system may further include a front short-range radar sensor.

The front short-range radar sensor may be configured to detect an object in a frontward direction of the school vehicle and measure a distance to the detected object,

In the aspect, the alarm controller is configured to generate an alarm with respect to a front side of the school vehicle when a distance to an object included in an object detection result received from the front short-range radar sensor is less than or equal to a first alarm distance.

In the aspect, the school vehicle safety system may further include a left side short-range radar sensor and a right side short-range radar sensor.

The left side short-range radar sensor may be configured to detect an object in a leftward direction of the school vehicle and measure a distance to the detected object.

The right side short-range radar sensor may be configured to detect an object in a rightward direction of the school vehicle and measure a distance to the detected object.

In the aspect, the alarm controller may be configured to generate an alarm with respect to a left-side and/or a right-side of the school vehicle when a distance to an object included in an object detection result received from the left-side and/or right side short-range radar sensor is less than or equal to a second alarm distance.

In addition, the alarm controller may stop the operation of the front short-range radar sensor, the left side short-range radar sensor, and the right side short-range radar sensor when the moving speed of the school vehicle received from the speed detection short-range radar sensor is greater than or equal to a preset second speed.

Other features and aspects will be apparent from the following detailed description, the drawings, and the claims

### BRIEF DESCRIPTION OF THE DRAWINGS

FIG. 1 is a block diagram of a school vehicle safety system using a radar sensor according to an embodiment of the present invention.

FIG. 2 illustrates an example of radar sensors included in the present invention that are installed in a school vehicle.

FIG. 3 conceptually illustrates a monitoring distance and an alarm distance of a front short-range radar sensor and left and right side short-range radar sensors included in the present invention.

FIG. 4 conceptually illustrates an example of a configuration of radar modules of a front short-range radar sensor included in the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The foregoing and additional aspects are embodied through embodiments described with reference to the attached drawings. It is understood that various combinations of the components of each embodiment are possible within the embodiment as long as there is no other mention or contradiction between them. In some cases, each block in a block diagram may represent a physical part, but in other cases, it may be a logical expression of a part of the function of one physical part or a function across multiple physical parts. Sometimes the entity of a block or part of the block may be a set of program instructions. All or some of these blocks may be implemented by hardware, software, or a combination thereof.

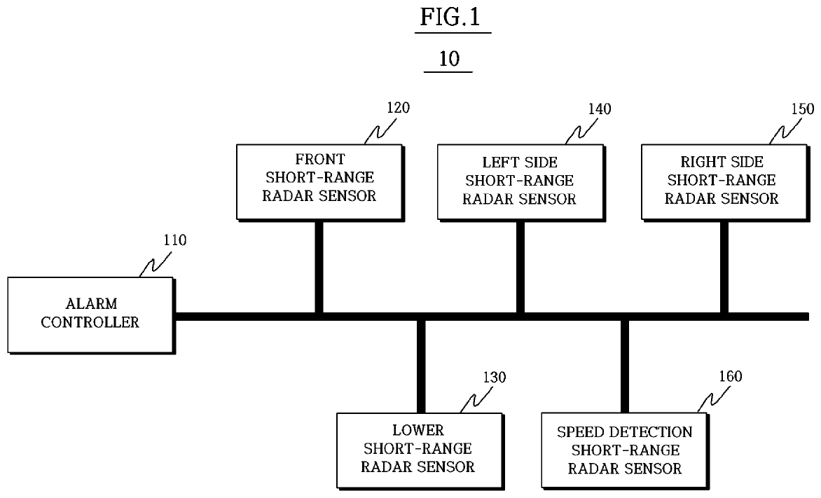

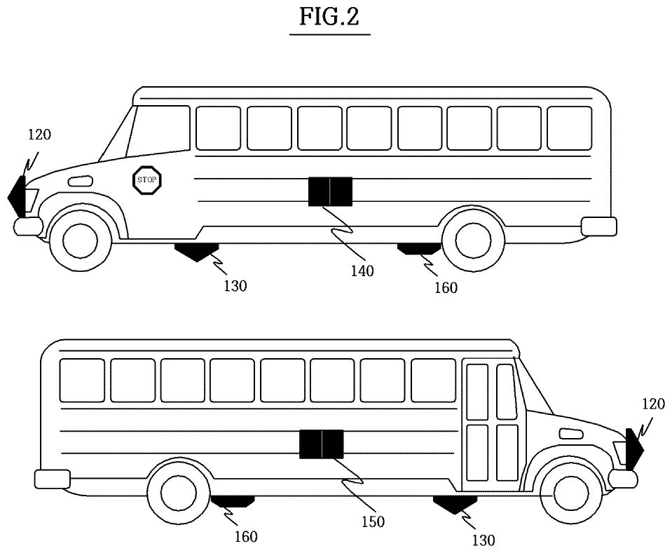

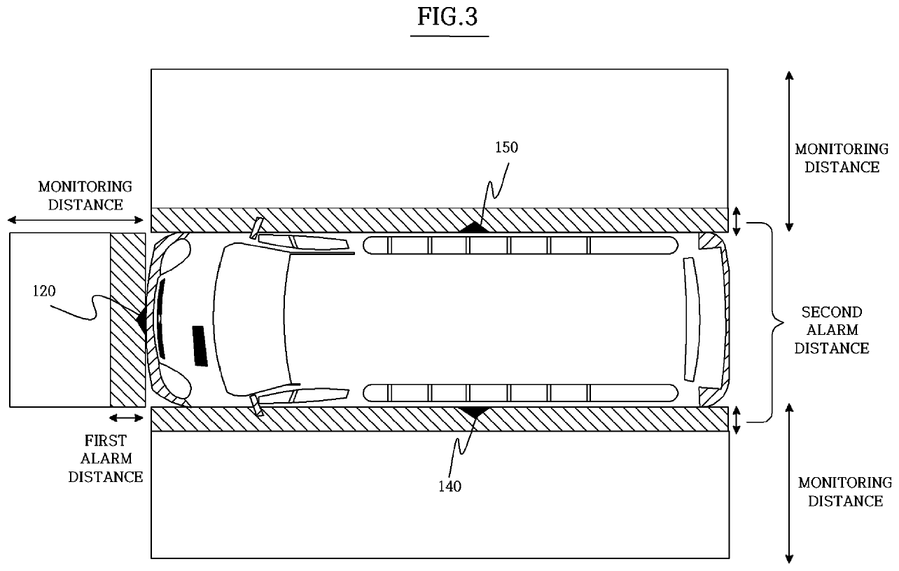

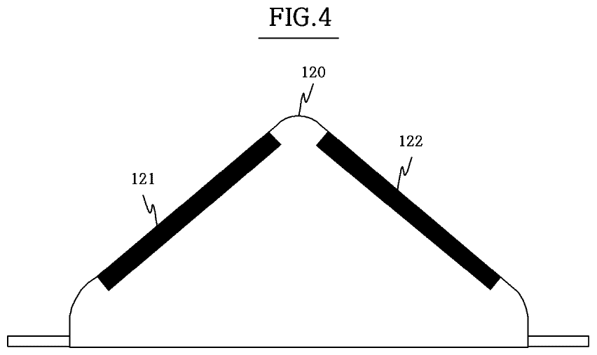

FIG. 1 is a block diagram of a school vehicle safety system using a radar sensor according to an embodiment of the present invention, FIG. 2 illustrates an example of radar sensors included in the present invention being installed in a school vehicle, FIG. 3 conceptually illustrates a monitoring distance and an alarm distance of a front short-range radar sensor and left and right side short-range radar sensors included in the present invention, and FIG. 4 conceptually illustrates an example of a configuration of radar modules of a front short-range radar sensor included in the present invention.

The components shown in FIG. 1 are connected via a vehicle network and are preferably connected in a bus topology. For example, each of the components shown in FIG. 1 may be connected via a controller area network (CAN) bus. However, this is not limited, and each of the components shown in FIG. 1 may be connected by other methods and connected via a local interconnect network (LIN), FlexRay, Ethernet, or the like.

Unlike that shown in FIG. 1, various aspects of the present invention may be implemented using only some of the components.

A school vehicle safety system 10 using a radar sensor according to one aspect of the present invention includes a lower short-range radar sensor 130 and an alarm controller 110.

The school vehicle safety system 10 according to the present invention is preferably applied to a relatively large vehicle such as a school bus. The present invention is not limited thereto, and the school vehicle safety system 10 according to the present invention may be applied to a passenger vehicle.

The lower short-range radar sensor 130 is an ultra-short range radar (USRR) or a short range radar (SSR). There is no limitation on the operation method of the lower short-range radar sensor 130, and a pulse Doppler method, a frequency modulated continuous wave (FMCW) method, a frequency shift keying (FSK) method, a UWB method, or the like may be used. The lower short-range radar sensor 130 is installed at the front lower side of the school vehicle to have a detection plane parallel to the bottom surface of the vehicle and sets a monitoring distance to about 10 m or less, preferably about 7 m, to detect an object moving under the school vehicle. For example, when the monitoring distance of the lower short-range radar sensor is set to 7 m, it is preferable to install the lower short-range radar sensor 130 at a position within 7 m from the rear of the vehicle. The installation position of the lower short-range radar sensor 130 needs to be determined in consideration of the size of the vehicle and the monitoring distance setting. FIG. 2 illustrates an example in which the lower short-range radar sensor 130 is installed at a lower side of the vehicle. The illustration of FIG. 2 is only an example, and the size and installation position of the radar sensor may differ from a case in which the lower short-range radar sensor 130 is installed at a lower side of an actual vehicle.

As for the lower side of the vehicle, various metal parts of the vehicle may be present, and the lower short-range radar sensor 130 may recognize that an object (e.g., a child) has been detected even when there is no object having entered a space under the vehicle due to scatter. To prevent such false object detection, the lower short-range radar sensor 130 employs a static clutter removal function to prevent a static object from being detected.

In addition, the lower short-range radar sensor 130 is a radar sensor with a field of view (FOV) of 180 degrees or more so that the entire area under the vehicle is monitored.

When the lower short-range radar sensor 130 detects a moving object below the vehicle, the lower short-range radar sensor 130 reports an object detection result through a connected vehicle network. Since the lower side of the vehicle is not identified by a driver through a rearview mirror or side view mirror, the lower short-range radar sensor 130 reports the object detection result every time the object is detected regardless of the detection distance.

The lower short-range radar sensor 130 may receive power through several wires of a cable (e.g., a UTP cable) used for a vehicle network connection.

The alarm controller 110 includes a speaker that outputs a buzzer sound or the like and one or more light emitting diodes (LEDs) that indicate generation of an alarm. For example, the alarm controller 110 may include six LEDs and may allow a predetermined LED to flash depending on a location at which an object is detected around the school vehicle.

The alarm controller 110 receives the object detection result from the lower short-range radar sensor 130 through the vehicle network. The lower short-range radar sensor 130 performs object detection on the lower side of the vehicle at preset intervals and reports an object detection result to the alarm controller 110 regardless of whether an object is detected or reports an object detection result to the alarm controller 110 only when an object is detected, and the alarm controller 110 determines whether an alarm has been generated from the lower side of the school vehicle based on the received object detection result.

When it is determined that a moving object is detected at the lower side of the vehicle as a result of the determination of the object detection result, the alarm controller 110 outputs a warning sound through the speaker and flashes one or more LEDs to indicate the detection. For example, since a situation in which a moving object is detected at the lower side of the vehicle is a very serious situation in relation to an accident, the alarm controller 110 may indicate the detection by flashing or lighting all LEDs.

According to an additional aspect of the present invention, the school vehicle safety system 10 using a radar sensor may further include a speed detection short-range radar sensor 160.

The speed detection short-range radar sensor 160 is an ultra-short-range radar (USRR) or a short-range radar (SSR). There is no limitation on the operation method of the speed detection short-range radar sensor 160, and a pulse Doppler method, a frequency modulated continuous wave (FMCW) method, a frequency shift keying (FSK) method, an UWB method, or the like may be used.

Since the lower short-range radar sensor 130 is provided to detect children who enter a space under the vehicle while the school vehicle is stopped for boarding or disembarking of children, an alarm generated from the lower side of the vehicle is recognized as being a serious situation. However, when the school vehicle is in operation, i.e., in motion, an object detection error that mistakes the road as a moving object may occur, resulting in a false alarm. In particular, when a false alarm is generated when the school vehicle starts from a stopped state, the driver may suddenly stop, which may cause other accidents. Therefore, the school vehicle safety system 10 needs to prevent such false alarms from being generated when the school vehicle starts traveling.

To this end, the school vehicle safety system according to the present invention detects the speed of the vehicle through the speed detection short-range radar sensor 160. The speed detection short-range radar sensor 160 is installed at a rear lower side of the school vehicle to form a first angle with the bottom surface of the school vehicle and emit a radar signal. That is, the speed detection short-range radar sensor 160 is installed such that the radar signal is emitted toward the ground at the rear of the vehicle. It is preferable that the speed detection short-range radar sensor 160 set a detection distance to less than 1 m, and it is preferable that the speed detection short-range radar sensor 160 be installed such that the emitted radar signal is at an angle of about 30 to 40 degrees with respect to the ground. The speed detection short-range radar sensor 160 emits a radar signal toward the ground at the rear of the vehicle and detects, that is, calculates, the moving speed of the school vehicle from a signal reflected from the ground. The speed detection short-range radar sensor 160 reports the calculated vehicle speed to the alarm controller 110 through the connected vehicle network.

The speed detection short-range radar sensor 160 may also receive power through several wires of a cable (e.g., a UTP cable) used for the vehicle network connection.

The school vehicle safety system 10 may obtain the vehicle speed from a global positioning system (GPS), but a delay time may occur, which may delay the detection of the vehicle beginning to depart. To avoid such a limitation, the school vehicle safety system 10 according to the present invention detects the vehicle speed using a short-range radar.

In this case, the alarm controller 110 may receive the moving speed of the vehicle from the speed detection short-range radar sensor 160, compare the received moving speed of the school vehicle with a preset first speed to determine whether the school vehicle has started from a stopped state, and when the moving speed of the vehicle is greater than the preset first speed, stop the operation of the lower short-range radar sensor 130. In this case, the first speed is preferably set to 0 m/s to detect the school vehicle starting from a stopped state. Therefore, the alarm controller 110 may allow the lower short-range radar sensor 130 to stop detecting objects at the lower side of the vehicle when the school vehicle is moving to prevent false alarms from being generated.

According to an additional aspect of the present invention, the school vehicle safety system 10 using a radar sensor may further include a front short-range radar sensor 120.

The front short-range radar sensor 120 is an ultra-short-range radar (USRR) or a short-range radar (SSR). There is no limitation on the operation method of the front short-range radar sensor, and a pulse Doppler method, a frequency modulated continuous wave (FMCW) method, a frequency shift keying (FSK) method, a UWB method, or the like may be used. The front short-range radar sensor 120 is installed at the front of the vehicle to emit radar signals to a detection area in front of the school vehicle and sets a monitoring distance to 10 m or less, preferably 7 m, to detect an approaching object from the front of the school vehicle and measure the distance to the detected object.

In the present aspect, the alarm controller 110 receives an object detection result from the front short-range radar sensor 120 through the vehicle network. The front short-range radar sensor 120 performs object detection at the front of the vehicle at preset intervals and measures, i.e., calculates, the distance to the object when the object is detected. After performing object detection, the front short-range radar sensor 120 reports an object detection result to the alarm controller 110 regardless of whether an object is detected or reports an object detection result to the alarm controller 110 only when an object is detected, and the alarm controller 110 determines whether an alarm has been generated from the front of the school vehicle based on the received object detection result.

The alarm controller 110 may generate an alarm with respect to the front of the school vehicle when the object is detected and the distance to the object is less than or equal to the first alarm distance as a result of determination of the object detection result that has been received. When the alarm controller 110 determines that an object is detected in front of the vehicle as a result of the determination of the object detection result, the alarm controller 110 outputs a warning sound through the speaker and flashes one or more LEDs to indicate the detection. For example, when an object is detected within the first alarm distance in front of the vehicle, the alarm controller 110 may flash or light a LED, which is predetermined to flash or light when an object is detected in front of the vehicle. The alarm controller 110 may set the first alarm distance, which is set to fall within the detection distance, i.e., the monitoring distance, and in consideration of accident prevention. For example, the first alarm distance may be set to 2 m.

The front short-range radar sensor 120 may also receive power through several wires of a cable (e.g., a UTP cable) used for the vehicle network connection.

According to an additional aspect of the present invention, the school vehicle safety system 10 using a radar sensor may further include a left side short-range radar sensor 140 and a right side short-range radar sensor 150.

The left side short-range radar sensor 140 and the right side short-range radar sensor 150 are ultra-short-range radars (USRR) or short-range radars (SSR). There is no limitation on the operation method of the left side short-range radar sensor 140 and the right side short-range radar sensor 150, and a pulse Doppler method, a frequency modulated continuous wave (FMCW) method, a frequency shift keying (FSK) method, a UWB method, or the like may be used.

The left side short-range radar sensor 140 is installed on the left side of the vehicle to emit radar signals to a left-side detection area of the school vehicle, and the monitoring distance is set to 10 m or less, preferably 7 m, to detect an object approaching from the left-side of the school vehicle and measure the distance to the detected object.

The right side short-range radar sensor 150 is installed on the right side of the vehicle to emit radar signals to a right-side detection area of the school vehicle, and the monitoring distance is set to 10 m or less, preferably 7 m, to detect an object approaching from the right-side of the school vehicle and measure the distance to the detected object.

In this aspect, the alarm controller 110 receives an object detection result from the left side short-range radar sensor 140 and/or the right side short-range radar sensor 150 through the vehicle network. The left side short-range radar sensor 140 and the right side short-range radar sensor 150 perform object detection on the left side and/or right side of the vehicle at preset intervals and measure, i.e., calculate, the distance to the object. After performing object detection, the left side short-range radar sensor 140 and the right side short-range radar sensor 150 report an object detection result to the alarm controller 110 regardless of whether an object is detected or report an object detection result to the alarm controller 110 only when an object is detected, and the alarm controller 110 determines whether an alarm has been generated from the left and/or right side of the school vehicle based on the received object detection result.

The alarm controller 110 may generate an alarm with respect to the left and/or right direction of the school when the object is detected and the distance to the object is less than or equal to a second alarm distance as a result of determination of the received object detection result. When the alarm controller 110 determines that an object is detected on the left and/or right side of the vehicle based on the result of the determination of the object detection result, the alarm controller 110 outputs a warning sound through a speaker and flashes one or more LEDs to indicate the detection. For example, when an object is detected within the second alarm distance at the left and/or right side of the vehicle, the alarm controller 110 may flash or light an LED that is predefined to flash or light when an object is detected on the left and/or right side of the vehicle to indicate the detection. The alarm controller 110 may set the second alarm distance, which is set to fall within the detection distance, i.e., the monitoring distance, and in consideration of preventing accidents. For example, the second alarm distance may be set to 0.6 m.

The left side short-range radar sensor 140 and the right side short-range radar sensor 150 may also be powered through several wires of a cable (e.g., an UTP cable) used for the vehicle network connection.

When a school vehicle is traveling at a speed higher than or equal to a certain speed, a false alarm may be generated in a situation unrelated to the safety of the school vehicle around the school vehicle. To prevent such a limitation, the alarm controller 110 may stop the operation of the front short-range radar sensor 120, the left side short-range radar sensor 140, and the right side short-range radar sensor 150 to prevent an alarm from being generated when the moving speed of the school vehicle received from the speed detection short-range radar sensor 160 is higher than or equal to the set second speed.

When children get on or get off the school vehicle, a safety bar may be extended to the front of the vehicle or a stop sign may be extended from the side of the vehicle, and children may board or disembark through a boarding and disembarking door. Due to such safety bars, stop signs, and boarding or disembarking of children, an alarm unrelated to an accident may be generated. In order to prevent such an alarm from being generated, there is a need to process an object detected in a part of an object detection area as not to be detected.

The school vehicle safety system 10 according to the present invention may set a part of an area in which an object may be detected as a detection exclusion area among at least one of the front short-range radar sensor 120, the left side short-range radar sensor 140, and the right side short-range radar sensor 150 to prevent an object from being detected in the detection exclusion area.

Each of the short-range radar sensors 120, 130, 140, and 150 that detect an object included in the school vehicle safety system according to the present invention may provide a FOV of 180 degrees or more by including two radar modules arranged to form a certain angle.

The exemplary radar sensor shown in FIG. 4 is a front short-range radar sensor 120 in which two radar modules 121 and 122 are coupled, but the lower short-range radar sensor 130, the left side short-range radar sensor 140, and the right side short-range radar sensor 150 may also have the shape shown in FIG. 4. Each radar module included in each short-range radar sensor for detecting an object included in the school vehicle safety system according to the present invention may be mounted on a single printed circuit board (PCB), and although the configuration may vary depending on the antenna arrangement, may provide a constant FOV (e.g., 120 degrees) in the horizontal and vertical directions. The short-range radar sensor for detecting an object included in the present invention may expand the FOV by fusing two such radar modules. For example, when a single radar module provides a FOV of 120 degrees in the horizontal direction, the short-range radar sensor for detecting an object included in the present invention may provide a FOV of 180 degrees or more by fusing two radar modules at a constant angle. In this case, when two radar modules are arranged at a certain angle, it is preferable that the FOV area of each radar module overlaps the FOV area of the other radar module. However, it is not limited to this configuration, and the FOV areas of each radar module may be arranged without overlapping each other.

The short-range radar sensor for detecting an object included in the present invention may be used by converting the coordinate system used by each radar module, i.e., the local coordinate system, into a common global coordinate system.

The positions, sizes, shapes, installation angles, and the like of the radar sensors shown in FIGS. 2 and 3 are conceptually illustrated, and the present invention is not limited thereto. For example, the speed detection short-range radar sensor 160 in FIG. 2 is illustrated as being installed parallel to the bottom of the vehicle, but this is for the sake of convenience of illustration, and in practice, the speed detection short-range radar sensor 160 may be installed to have a certain inclination angle as described above.

As is apparent from the above, the safety management technology according to the present invention can detect the approach of a child approaching the vicinity of a school vehicle using a radar and generate an alarm.

In addition, the safety management technology according to the present invention can detect a child who has entered a space under a school vehicle using a radar and generate an alarm.

In addition, the safety management technology according to the present invention can detect a departure of a school vehicle without a delay using a radar and prevent unneeded alarms from occurring due to movement of the vehicle.

The various embodiments disclosed in this specification and drawings are merely presented as specific examples to help understanding and are not intended to limit the scope of the various embodiments of the present invention. Accordingly, the scope of the various embodiments of the present invention should be interpreted as including all changes or modified forms derived based on the technical ideas of the various embodiments of the present invention in addition to the embodiments described herein.

What is claimed is:

1. A school vehicle safety system using a radar sensor, comprising:
a lower short-range radar sensor configured to detect a moving object at a forward lower side of a school vehicle; and
an alarm controller configured to receive an object detection result from the lower short-range radar sensor, determine whether an alarm has been generated from a lower side of the school vehicle, output a warning sound through a speaker, and flash one or more light emitting diodes (LEDs) according to a result of the determination to indicate the result of the determination.

2. The school vehicle safety system of claim 1, further comprising a speed detection short-range radar sensor configured to emit a radar signal at a first angle with respect to a bottom surface of the school vehicle at a rear lower side of the school vehicle and detect a moving speed of the school vehicle based on a signal reflected from the radar signal.

3. The school vehicle safety system of claim 2, wherein the alarm controller is configured to stop an operation of the lower short-range radar sensor when the moving speed of the school vehicle received from the speed detection short-range radar sensor is greater than a preset first speed.

4. The school vehicle safety system of claim 2, further comprising a front short-range radar sensor configured to detect an object in a forward direction of the school vehicle and measure a distance to the detected object,
wherein the alarm controller is configured to generate an alarm with respect to a front side of the school vehicle when a distance to an object included in an object detection result received from the front short-range radar sensor is less than or equal to a first alarm distance.

5. The school vehicle safety system of claim 4, further comprising:
a left side short-range radar sensor configured to detect an object in a leftward direction of the school vehicle and measure a distance to the detected object; and
a right side short-range radar sensor configured to detect an object in a rightward direction of the school vehicle and measure a distance to the detected object,
wherein the alarm controller is configured to generate an alarm with respect to a left-side and/or a right-side of the school vehicle when a distance to an object included in an object detection result received from the left and/or right side short-range radar sensor is less than or equal to a second alarm distance.

6. The school vehicle safety system of claim 5, wherein the alarm controller stops operations of the front short-range radar sensor, the left side short-range radar sensor, and the right side short-range radar sensor when the moving speed of the school vehicle received from the speed detection short-range radar sensor is greater than or equal to a preset second speed.

7. The school vehicle safety system of claim 5, wherein each of the short-range radar sensors includes two radar modules arranged at a certain angle to provide a field of view (FOV) of 180 degrees or more.

8. The school vehicle safety system of claim 5, wherein at least one short-range radar sensor among the front short-range radar sensor, the left side short-range radar sensor, and the right side short-range radar sensor is configured to set a part of an area in which an object is detectable as a detection exclusion area to prevent an object from being detected in the detection exclusion area.
